(19) United States
(12) Patent Application Publication
(10) Pub. No.: US 2005/0144113 A1
(43) Pub. Date: Jun. 30, 2005

(54) Methods and apparatus for facilitating financial instrument trading orders

(76) Inventors: Daniel Opperman, Warren, NJ (US); Rishi Nangalia, New York, NY (US); Christopher Truchan, Bronx, NY (US)

Correspondence Address: BUCKLEY, MASCHOFF, TALWALKAR LLC, 5 ELM STREET, NEW CANAAN, CT, 06840, US

(21) Appl. No.: 10/780,313

(22) Filed: Feb. 17, 2004

Related U.S. Application Data
(60) Provisional application No. 60/532,391, filed on Dec. 24, 2003.

(51) Int. Cl. G06F 17/60

(52) U.S. Cl. 705/37

(57) ABSTRACT

According to some embodiments, components of a financial trading network may display financial instrument trading information on a display screen. The financial instrument trading information may include a first menu for displaying a first set of alternatives with respect to a first order parameter such as a trading symbol or an order destination. User input may be received to indicate selection of an alternative from the first set of alternatives. A second menu may also be displayed as part of the financial instrument trading information. The second menu may be for displaying a second set of alternatives with respect to a second order parameter such as an order destination or an order type. The second set of alternatives which constitute the second menu may be selected based at least in part on the alternative selected by the user from the first set of alternatives.

### RELATED APPLICATION

This application is based on, and claims priority to, U.S. Provisional Application Ser. No. 60/532,391, filed Dec. 24, 2003, for “Methods and Apparatus for Facilitating Financial Instrument Trading Orders.” The contents of the above referenced provisional patent application are incorporated by reference herein in their entirety.

### FIELD

The present invention relates to electronic trading of securities and other financial instruments. In some embodiments, the present invention relates to methods and apparatus for facilitating entry of trading orders.

### BACKGROUND

Electronic trading is ubiquitous in today's financial community. Generally, electronic trading allows traders to place orders through a user device such as a desktop computer.

Architectures of electronic trading systems vary widely. In some systems, a trader interacts with an electronic trading platform presented by the user device. The electronic trading platform may be an internally-developed system or an off-the-shelf system, such as the REDIPlus™ system. The electronic trading platform may communicate with pools of liquidity directly or through a routing and order management network, such as REDINet™. Such pools of liquidity, which may also be thought of as trading market places, include listed exchanges, ECNs (Electronic Communication Networks), market makers, options exchanges, futures exchanges, and the like. An electronic trading platform and/or management network may also communicate with in-house back-end systems to provide trade reporting and tracking functions to the trader.

Many electronic trading platforms and management networks are currently available, each providing specific features. Many of these features are intended to clearly present market information to a trader, and others are intended to facilitate trading functions.

In recent years, the number of trading market places has greatly increased, and so have the types of orders and other service options provided by the trading market places. Moreover, the various trading market places increasingly offer types of orders and other service options that differ from market place to market place. Improvements in trading platforms are now needed to help in guiding traders through the veritable maze of possibilities that the current trading environment offers.

### SUMMARY

To address the foregoing, embodiments of the present invention concern a method, an apparatus, and a medium storing processor-executable process steps to display financial instrument trading information on a screen. The financial instrument trading information includes a first menu for displaying a first set of alternatives with respect to a first order parameter. The present invention further includes receiving user input that indicates selection of an alternative from the first set of alternatives, and displaying a second menu as part of the financial instrument trading information. The second menu is for displaying a second set of alternatives with respect to a second order parameter. The second set of alternatives which constitute the second menu are selected based at least in part on the alternative selected by the user input from the first set of alternatives.

As used herein and in the appended claims, “financial instrument” includes an equity security such as a common stock, a debt security, an option, a futures contract or a currency trading contract. As used herein, an “option” refers to a contract that includes the right but not the obligation to buy or sell a stock or other security for a specified price on or before a specific date.

In another aspect, the invention includes displaying financial instrument trading information on a screen, where the financial instrument trading information includes a first menu for displaying a first set of alternatives with respect to a first order parameter. The invention according to this aspect further includes receiving user input that indicates selection of an alternative from the first set of alternatives, and displaying a second menu as part of the financial instrument trading information. The second menu is for displaying a second set of alternatives with respect to a second order parameter and is selected based at least in part on the alternative selected by the user input from the first set of alternatives.

In still another aspect, the invention includes displaying a first order type menu at times when a first order destination alternative is selected from an order destination menu, and displaying a second order type menu at times when a second order destination alternative is selected from the order destination menu, where the second order type menu is different from the first order type menu.

As used herein and in the appended claims, “order destination” refers to any one or more of a securities exchange, a market maker and an ECN or any trading market place.

In yet another aspect, the invention includes displaying a first order destination menu at times when a first financial instrument trading symbol is displayed in an order input area of a user interface, and displaying a second order destination menu at times when a second financial instrument trading symbol is displayed in the order input area, where the second order destination menu is different from the first order destination menu.

As used herein and in the appended claims, “financial instrument trading symbol” refers to a brief string of letters and/or numerals that is used to identify a financial instrument for purposes of trading and/or price quotation.

Thus, in some aspects, a user interface for inputting parameters required to place an order may be context sensitive, in that the information requested of the user by the interface may vary according to information that has already been entered by the user with respect to the order. As a result, the interface according to the invention may be easier to use than prior interfaces, and may relieve the user of much or all of the burden of tracking the data required for various order destinations, order types, etc.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is a block diagram of a system consistent with the present invention.

FIG. 2 is a block diagram of one embodiment of an order processing server for use in conjunction with the system of FIG. 1.

FIG. 3 is a block diagram of one embodiment of a user device for use in conjunction with the system of FIG. 1.

FIGS. 4-9 are outward views of user interfaces according to some embodiments of the invention.

FIG. 10 is a flow diagram that illustrates an exemplary process for providing at least some of the interfaces shown in FIGS. 4-9.

FIG. 11 is a flow diagram that illustrates an exemplary process for providing at least some of the interfaces shown in FIGS. 4-9.

FIG. 12 is a flow diagram that illustrates an exemplary process for providing at least some of the interfaces shown in FIGS. 4-9.

### DETAILED DESCRIPTION

In general, and for the purposes of introducing concepts of embodiments of the present invention, a user interface for financial instrument trading order entry may determine which menus to display, or what alternatives to include in one or more menus, based on a menu alternative selected by the user or based on data entered by the user. Thus the menus presented, or menu items presented, may be context sensitive, and may guide the user to properly complete an order entry process. The order entry interface may be highly flexible and may allow the user to successfully navigate a large number of order entry possibilities, including a considerable number of possible order destinations and/or order types.

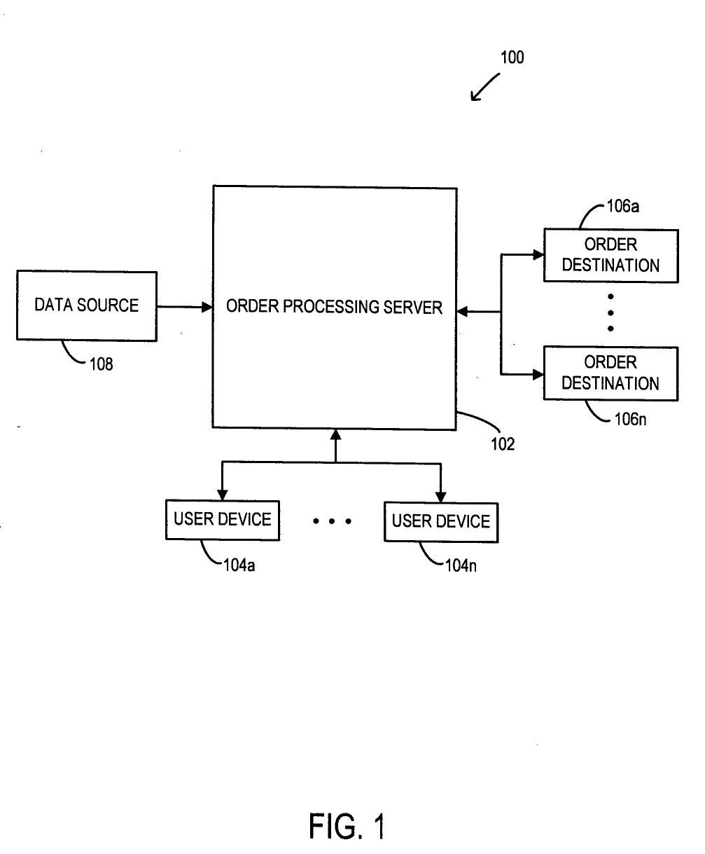

Features of some embodiments of the present invention will now be described by first referring to FIG. 1, where a block diagram of one embodiment of a trading network 100 is shown. As shown, trading network 100 includes a number of different components which cooperatively operate to process and execute securities trading orders pursuant to some embodiments of the present invention.

As depicted, trading network 100 includes an order processing server 102 in communication with one or more user device(s) 104, a plurality of order destinations 106, and a source 108 of market data. Order processing server 102 may function as a host computer for the user devices 104 and may operate to receive and execute financial instrument trading orders on behalf of users of the user devices 104. In some embodiments, order processing server 102 may function to timestamp orders when received and to assign an order identifier or sequence number to each order. In cases where input from the user via a user device indicates selection of a particular order destination, the order processing server may implement the user's selection by routing the order to the selected order destination. When an order as defined by the user does not prescribe an order destination, the order processing server 102 may operate to automatically route the order to one or more of the order destinations selected by the order processing server 102.

The order processing server 102 also operates to receive from the data source 108 data concerning market conditions. Such data may include, for example, information concerning the current status of order books at the order destinations 106. Thus the data supplied by the data source 108 may include current price quotations for financial instruments to be traded via the trading network 100. The order processing server 102 may also maintain and update databases based on the data received from data source 108 and may provide market data to the users via the user devices 104.

Although a single order processing server 102 is shown in FIG. 1, any number of order processing servers may be included in trading network 100. Similarly, any number of data sources 108, user devices 104, order destinations 106, or any other device described herein may be included in the trading network 100 according to embodiments of the present invention.

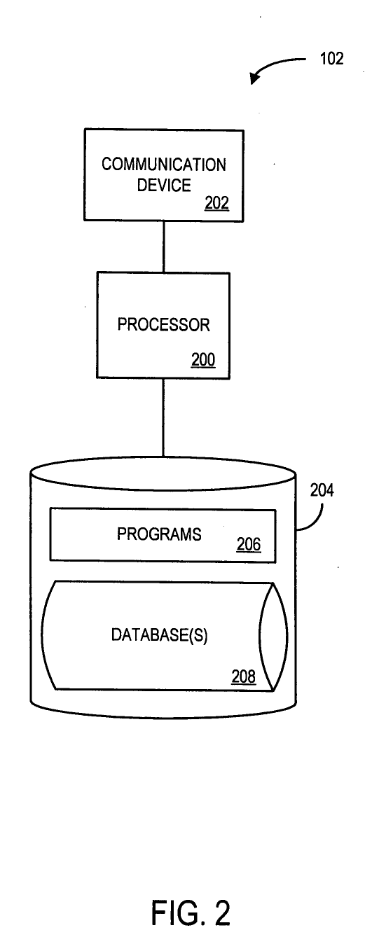

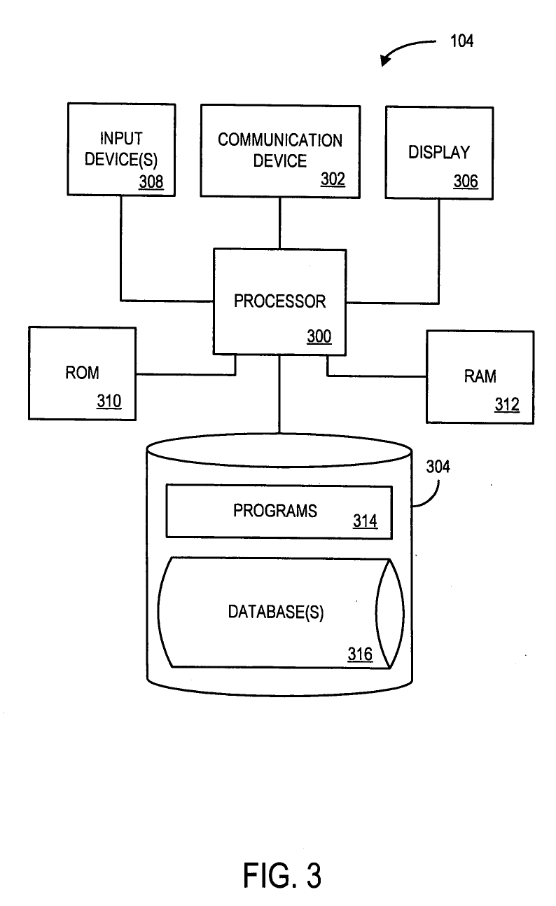

Each of the devices of trading network 100 may be formed of components or other devices capable of performing the various functions described herein. Exemplary embodiments of the order processing server 102 and of a user device 104 will be described below with reference to FIGS. 2 and 3, respectively.

An order destination 106 may include any computing device(s) operated by or on behalf of one or more order destinations. Each of the order destinations 106 may be in communication with other devices described herein, such as the order processing server 102 and the data source 108, using techniques known in the art.

As used herein, devices (e.g., order processing server 102, user devices 104, order destinations 106, and data source 108) may communicate, for example, via one or more communication networks. For example, some or all of the devices may be in communication via an Internet Protocol (IP) network such as the Internet. Some or all of the devices may be in communication via other types of networks such as an intranet, a Local Area Network (LAN), a Metropolitan Area Network (MAN), a Wide Area Network (WAN), a proprietary network, a Public Switched Telephone Network (PSTN), and/or a wireless network.

According to some embodiments of the present invention, communication between some or all of the devices of trading network 100 may be via temporary computer communication channel (e.g., a logic path through which information can be exchanged). In other words, the communication channel between various devices may be established and discontinued as appropriate. For example, order processing server 102 may exchange information with one of the order destinations 106 only when communication is necessary to transmit an order for execution by the order destination 106 or to receive confirmation from the order destination 106 that the order was executed.

According to some embodiments, some or all of the devices may communicate with other devices via a public computer communication network. That is, at least a portion of the communication network may be accessed by devices other than the devices depicted in FIG. 1. Note, however, that the information exchanged between order processing server 102 and other devices in FIG. 1 may be encrypted or otherwise protected to prevent a third party from accessing, manipulating, understanding and/or misusing the information. In some embodiments, some or all of the devices may communicate over a private network.

In other embodiments, the devices of FIG. 1 are connected differently than as shown. For example, some or all of the devices may be connected indirectly to one another (e.g., via the Internet). Of course, embodiments of the invention may include devices that are different from those shown. It should also be noted that although the devices are shown in communication with each other, the devices need not be constantly exchanging data. Rather, communication may be established when necessary and severed at other times or always available but rarely used to transmit data. Moreover, although the illustrated communication links appear dedicated, it should be noted that each of the links may be shared by other devices.

Reference is now made to FIG. 2, where an embodiment of order processing server 102 is shown. As depicted, order processing server 102 includes a computer processor 200 operatively coupled to a communication device 202 and a storage device 204.

Processor 200 may be constituted by one or more conventional processors, and may, for example, comprise RISC-based and other types of processors. Processor 200 operates to execute processor-executable process steps so as to control the elements of order processing server 102 to provide desired functionality.

Communication device 202 may be used to facilitate communication with, for example, other devices (such as user devices 104, order destinations 106 and data source 108). Communication device 202 is therefore preferably configured with hardware suitable to physically interface with desired external devices and/or network connections. For example, communication device 202 may comprise an Ethernet connection to a local area network through which order processing server 102 may receive and transmit information over the World Wide Web.

Storage device 204 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices.

Storage device 204 stores one or more programs 206 for controlling processor 200. The programs 206 comprise processor-executable process steps of order processing server 102, and may include process steps that constitute processes provided in accordance with principles of the present invention to implement a user interface described below. Processor 200 performs instructions of programs 206, and thereby may operate in accordance with the present invention. In some embodiments, programs 206 may be configured, at least in part, as a neural network or other type of program using techniques known to those skilled in the art to achieve the functionality described herein. Among the functions implemented via the programs 206 may be host server functions and order processing and execution functions.

Any or all process steps of order processing server 102 may be read from a computer-readable medium, such as a floppy disk, a CD-ROM, a DVD-ROM, a Zip™ disk, a magnetic tape, or a signal encoding the process steps, and then stored in storage device 204 in a compressed, uncompiled and/or encrypted format. Processor-executable process steps being executed by processor 200 may typically be stored temporarily in RAM (not separately shown) and executed therefrom by processor 200. In alternative embodiments, hard-wired circuitry may be used in place of, or in combination with, processor-executable process steps for implementation of processes according to embodiments of the present invention. Thus, embodiments of the present invention are not limited to any specific combination of hardware and software.

Storage device 204 may also store databases 208, including, for example, a database containing current market condition data (e.g., including current quotations for financial instruments) and a database containing data that indicates choices available to users of the user devices 104 relative to order destinations and types of orders that may be submitted. Other databases may also be provided (e.g., order and execution data may also be stored in storage device 204).

There may also be stored in storage device 204 other unshown elements that may be necessary for operation of order processing server 102, such as an operating system, a database management system, other applications, other data files, and “device drivers” for allowing processor 200 to interface with devices in communication with communication device 202. These elements are known to those skilled in the art, and are therefore not described in detail herein.

Although not shown in the drawing, the order processing server 102 may also include one or more input and/or output devices to permit a system administrator or other user to provide input to the processor 200 or to receive output from the processor 200.

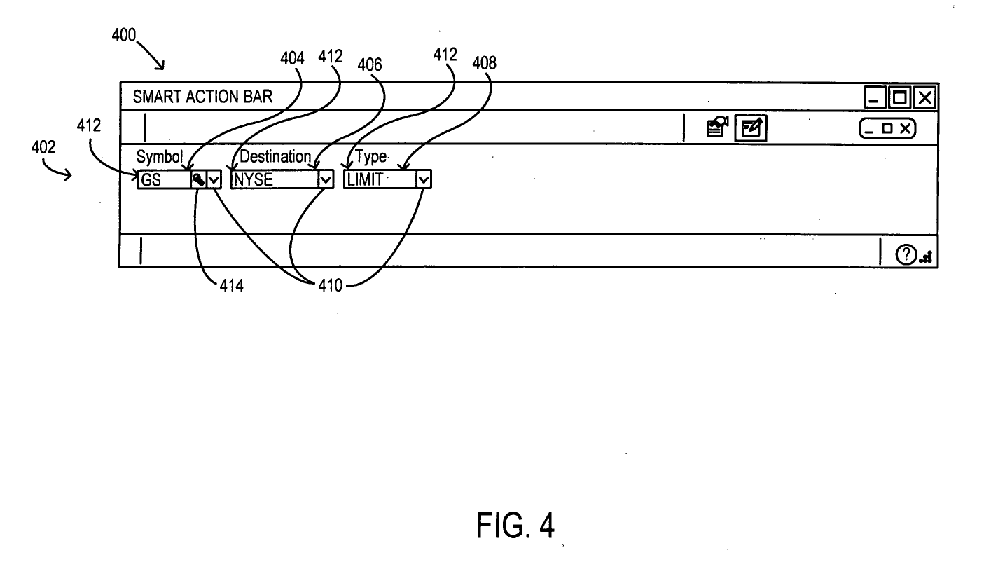

Reference is now made to FIG. 3, where an embodiment of a user device 104 is shown. As depicted, user device 104 includes a processor 300 operatively coupled to a communication device 302, a storage device 304, a display 306, one or more input devices 308, ROM 310 and RAM 312. Some or all of the hardware constituting the user device 104 may be conventional personal computer (PC) hardware. Thus the processor 300 may be a conventional Pentium® processor, for example, and the communication device 302 may be a conventional communication port which enables the user device 104 to exchange data with the order processing server 102 via, e.g., an Ethernet connection. The storage device 304 may include a conventional hard disk drive or other mass storage device. The display 306 may be a conventional CRT or flat panel computer monitor. The display 306 has a screen (not separately shown) by which a user interface in accordance with principles of the present invention, as described below and illustrated in FIGS. 4-9, may be presented to a user of the user device 104.

The input devices 308 may include a conventional keyboard and/or a conventional pointing device such as a mouse or trackball. ROM 310 may store basic input/output instructions and instructions used during boot-up of user device 104. RAM 312 provides fast data storage and retrieval and thus may function as working memory for processor 300. In addition, RAM 312 may temporarily store instructions corresponding to processor-executable process steps being executed by processor 300.

Storage device 304 stores one or more programs 314 for controlling processor 300. The programs 314 comprise processor-executable process steps of user device 104, and may include process steps that constitute processes provided in accordance with principles of the present invention, as described in more detail below. Processor 300 performs instructions of programs 314, and thereby may operate in accordance with the present invention. The programs 314 may include, for example, a conventional operating system such as the Windows operating system, as well as device drivers and a client side application that enables the user device 104 to interact with order processing server 102. A software program or programs which cause the user device 104 to display the user interface of the present invention may reside primarily in the order processing server 102 or in the storage device 304 of the user device 104 or may be distributed between the order processing server 102 and the user device 104.

Storage device 304 may also store one or more databases 316, which may, for example, store data downloaded from the order processing server 102. This data may include, for example, data concerning current market conditions and/or data indicative of choices that the user of the user device 104 may be allowed to make in terms of order destinations and order types or other parameters of financial instrument trading orders.

FIG. 4 is an outward view of at least a portion of a user interface provided in accordance with principles of the present invention. As seen from FIG. 4, the user interface of the present invention may include an interface element 400 which is in the form of a bar. The bar 400 may have a plurality of data input elements 402 arranged along the bar 400. For example, in some embodiments, the bar 400 may initially display three basic order entry data input elements 402, namely a symbol input element 404, an order destination data input element 406 and an order type data input element 408. Some or all of order entry data input elements 402, including the elements 404, 406, 408, may include a pull down menu. That is, when the user actuates a pull down button 410 with a cursor (not shown), the data entry input element displays and/or makes available to the user a plurality of alternatives which each represent a data entry that the user may select for the order entry data input element. In addition, or alternatively, one or more of the order entry data input elements may allow the user to directly enter alphanumeric data in a data field 412 via the keyboard (not separately shown) of the user device 104. The symbol data input element 404 may, in some embodiments, also have a look up button 414 which the user may actuate to access a look up function that is associated with the symbol data input element 404 to allow the user to look up symbols for entry into the data field 412 of the symbol data input element 404.

As will be discussed below, the particular alternatives displayed by the pull down menu constituting the order destination data input element 406 may vary depending on the particular symbol currently displayed in the data field 412 of the symbol data input element 404. Thus the alternatives available for selection by the user with respect to the order destination data input element 406 may correspond to only those order destinations which handle trading of the financial instrument indicated by the symbol currently displayed in the data field 412 of the symbol data input element 404. In this way, the user may be guided to select only appropriate entries for the order destination, and the user may not be required to know or memorize the order destinations that are suitable for each symbol.

Similarly, the particular alternatives displayed by the pull down menu constituting the order type data input element 408 may vary depending on the particular order destination currently displayed in the data field 412 of the order destination data input element 406. The alternatives available for selection by the user with respect to the order type data input element 408 may correspond to only those order types supported by the order destination currently displayed in the data field 412 of the order destination data input element 406 and/or may correspond only to those order types provided by the order destination currently displayed in the data field 412 of the order destination data input element 406 for the particular financial instrument indicated by the symbol currently displayed in the data field 412 of the symbol data input element 404. In this way, the user may be guided to select only appropriate entries for the order type, and the user may not be required to know or memorize the order types that are suitable for each order destination or for each combination of symbol and order destination.

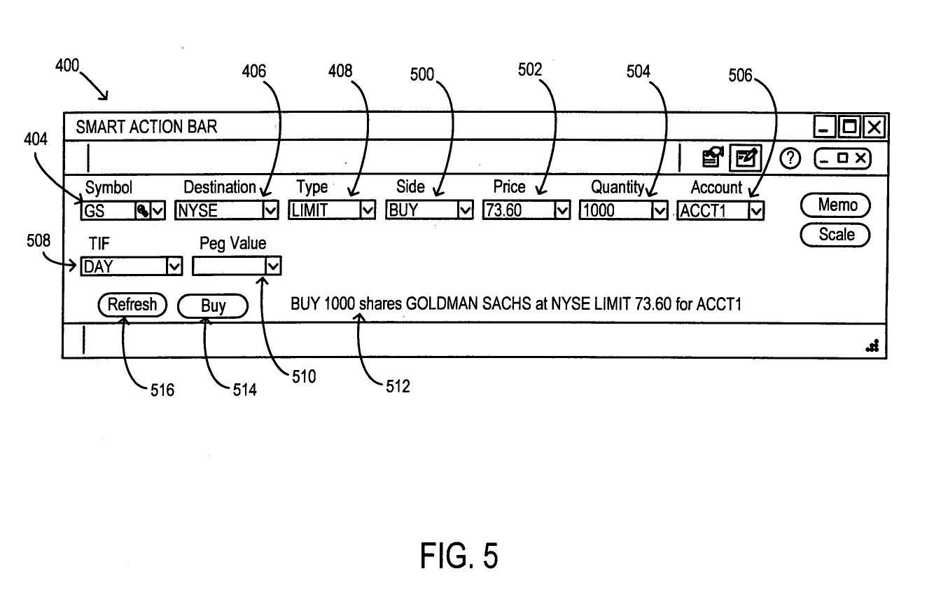

Once the user has indicated (e.g., by pressing an “enter” key on the keyboard) that the user has completed entering data in the data input elements 404, 406, 408, the user device 104 and/or the order processing server 102 may cause the bar 400 to be populated with additional data input elements, as illustrated in FIG. 5. The additional data input elements selected to be displayed may, as discussed further below, be those needed to input data that is appropriate for the combination of symbol, order destination and order type currently displayed in the data fields 412 of the data input elements 404, 406, 408. Some or all of the additional data input elements may include a pull down menu. In addition, or alternatively, one or more of the additional order entry data input elements may allow the user to directly enter alphanumeric data in a data field of the order entry data input element via the keyboard (not separately shown) of the user device 104.

FIG. 5 shows a particular example of a set of additional data input elements that may be appropriate for the combination of symbol, order destination and order type shown in FIG. 5. In this particular example, the additional data input elements include a “side” (i.e., side of the transaction such as “buy” or “sell”) data input element 500, a price data input element 502, a quantity data input element 504, an account data input element 506, a time in force (TIF) data input element 508 and a peg value data input element 510. In other embodiments and/or for other combinations of symbol, order destination and order type and/or for other configurations selected by the user or by the system administrator, the set of data input elements displayed on the bar 400 may be different from the set of data input elements shown in FIG. 5.

The data input elements allow the user to enter data corresponding to parameters that define an order to be submitted using the user device 102. Such parameters may be referred to as “order parameters”. In the particular example shown in FIG. 5, the symbol input data element 404 allows the user to enter a symbol that indicates the financial instrument to be traded; the order destination data input element 406 allows the user to enter an order destination to which the order is to be sent for execution; the order type data input element 408 allows the user to enter the type of the order (e.g., limit, market, etc.); the side data input element 500 allows the user to enter the “side” (buy or sell) for the order; the price data input element 502 allows the user to enter a price at which the order is to be executed; the quantity data input element 504 allows the user to enter the size (e.g., number of shares or number of contracts) of the order; the account data input element 506 allows the user to enter an account identifier that identifies the customer or account for which the order is being submitted; the TIF data input element 508 allows the user to indicate for what period of time the order is to be effective; and the peg value data input element 510 allows the user to indicate a peg value by which the order execution price may be linked to a current quotation price for the financial instrument.

In some embodiments and/or in some cases, some of the data input elements may correspond to order parameters which are required to define the order, whereas other data input elements may correspond to order parameters which are optional. In some embodiments, color coding or different font styles or the like may be employed to indicate which data input elements correspond to required order parameters and which data input elements correspond to optional order parameters. In the particular example illustrated in FIG. 5, all of the data input elements except for the peg value data input element 510 may correspond to required order parameters and the peg value data input element 510 may correspond to an optional order parameter.

The bar 400, as shown in FIG. 5, also includes a text field 512 which displays text to indicate the order as defined by the order parameter data currently entered in the input data elements. If the user finds that the order is correctly indicated in the text field 512, he or she may use the cursor (not shown) to actuate a button 514. In some embodiments, the button 514 is labeled “buy” or “sell” in accordance with the side entered at side data input element 500. Assuming that all required order parameters have been entered, actuation of the button 514 causes the user device 104 and/or the order processing server 102 to execute the order in accordance with the parameter values indicated in the text field 512. If the button 514 is actuated at a time when less than all of the required order parameters have been entered, an error message (not shown) may pop up as part of the user interface. The error message may indicate to the user which order parameter or parameters remain to be entered.

The bar 400 may also include a refresh button 516. The user may actuate the refresh button to clear the values entered in the data input elements and to return the bar 400 to a condition in which only the three primary data input elements 404, 406, 408 are displayed.

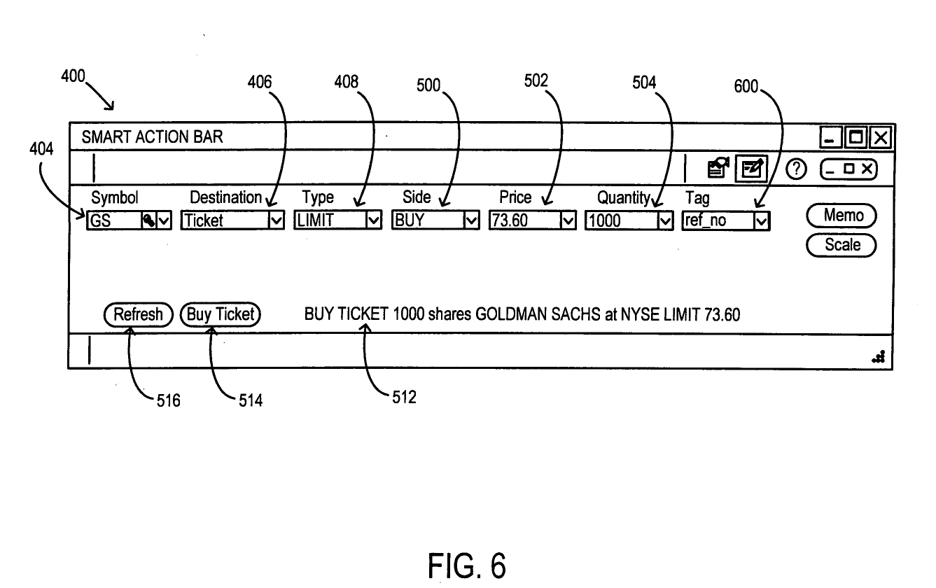

In some embodiments, the interface element or bar 400 may be used to create an order ticket instead of entering an order for immediate execution. The ticket creation function of the bar 400 may be accessed by selecting a “ticket” alternative from the order destination data input element 406. FIG. 6 shows an example of how the bar 400 may appear when it is being used to create a ticket. It will be observed from FIG. 6 that the same data input elements 404, 406, 408, 500, 502 and 504 as were discussed above in connection with FIGS. 4 and 5 may be displayed when the bar 400 is being used to create a ticket. However, the data input elements 506, 508, 510 shown in FIG. 5 may not be relevant to creating a ticket and may be omitted when the bar 400 is being used to create a ticket. Continuing to refer to FIG. 6, a “tag” data input element 600 may be displayed in addition to the data input elements 404, 406, 408, 500, 502, 504 when the bar 400 is being used to create a ticket. The tag data input element 600 allows the user to enter data that may be used to identify the ticket. The text field 512 displays text that indicates the parameter values currently selected for the proposed ticket. The button 514 is labeled “buy ticket” when the value “ticket” is selected from the order destination data input element 406 and the value “buy” is selected from the side data input element 500. When the value “ticket” is selected from the order destination data input element 406, actuation of the button 514 causes the user device 104 and/or the order processing server 102 to complete creation of a ticket in accordance with the parameter values displayed in the text field 512 (assuming that all data required for a ticket has been entered).

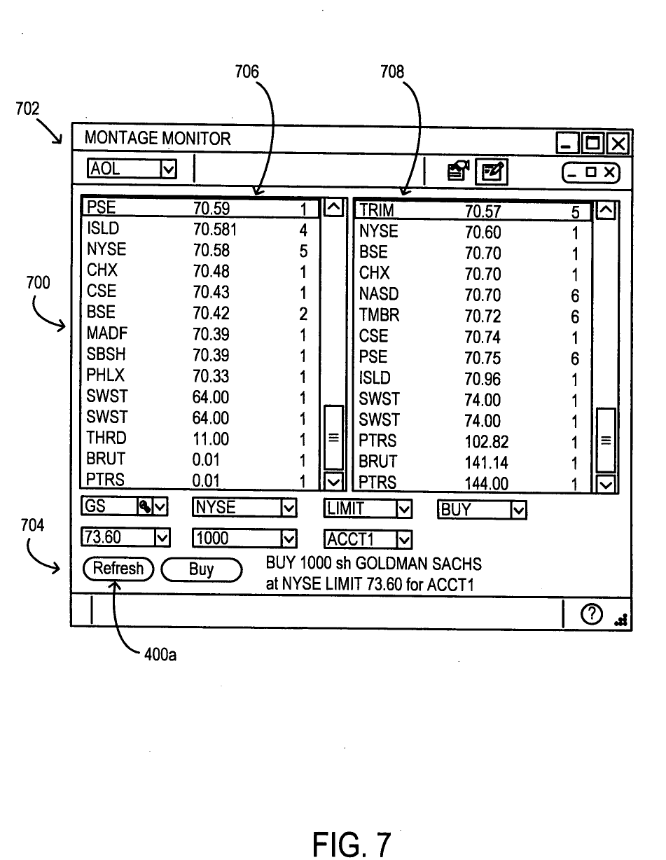

FIGS. 4-6 show the bar 400 in isolation and in a certain format. However, the format of the bar 400 may be changed and, in practice, the bar 400 may at least some of the time be combined with other user interface elements displayed on the screen of the display 306 (FIG. 3) of the user device 104. FIGS. 7-9 show examples of user interface display views that may be provided in accordance with the invention and that include a bar that is similar in functionality to the bar 400 and is displayed in combination with other user interface elements.

FIG. 7, in particular, shows a so-called “montage” view in which current quotation information is provided in an upper portion 700 of a screen display area 702, and a bar 400a that is similar in functionality to the bar 400 described above is displayed in a lower portion 704 of the screen display area 702. At the left side 706 of the upper portion 700 of the display area 702, bid quotations for various order destinations may be listed in declining order of price. At the right side 708 of the upper portion 700 of the display area 702, ask quotations for various order destinations may be listed in ascending order of price. The bar 400a is in a somewhat different format from the bar 400, but, like the bar 400, the bar 400a gathers together a number of different data input elements such as pull down menus that may be used to define the parameter values for an order to be entered via the user device 104. The number of data input elements included in the bar 400a, the types of data to be entered via the data input elements, and/or the particular alternatives offered for selection via the data input elements may vary from embodiment to embodiment and/or may vary with changes in the particular alternatives selected from certain ones of the data input elements.

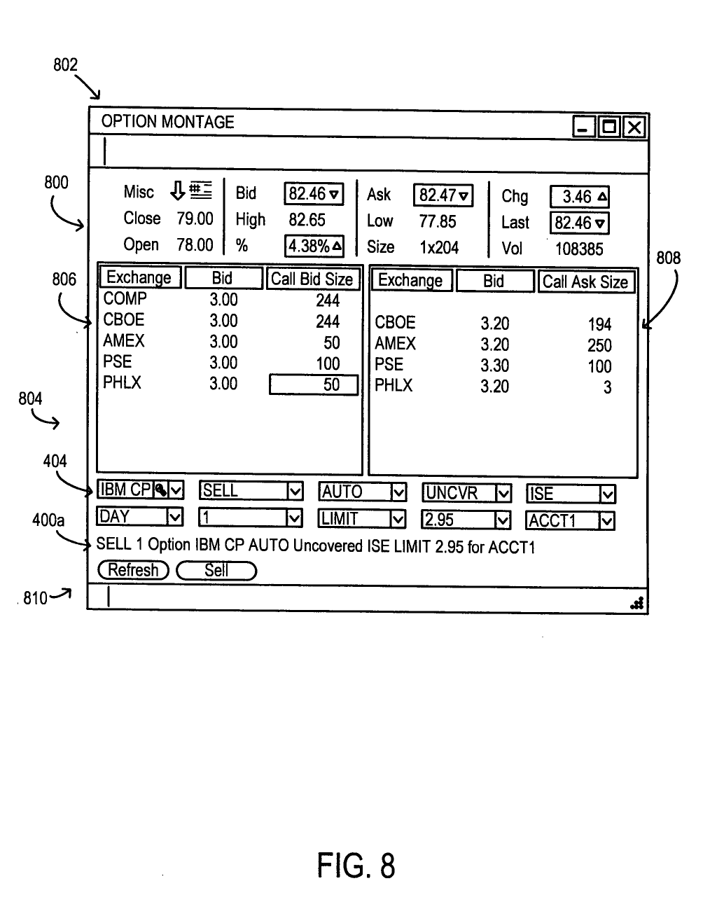

FIG. 8 shows another montage view of a type suitable for displaying information useful in options trading. At an upper portion 800 of a screen display area 802, current market information and recent historical market information is displayed with respect to an underlying equity security. At a middle portion 804 of the screen display area 802, current quotation information is displayed in regard to an option that corresponds to the underlying security. In particular, at a left side 806 of the middle portion 804, bid quotations for the option at various order destinations are listed in declining order of price. At a right side 808 of the middle portion 804, ask quotations for the option at various order destinations are listed in ascending order of price. The bar 400a is displayed at a lower portion 810 of the screen display area 802. The symbol entered into the symbol data input element 404 may indicate an option, as shown in FIG. 8. When the symbol entered into the symbol data input element 404 indicates an option, the data input elements which populate the bar 400a may be different from those displayed when the symbol indicates an equity security and may correspond to the types of, and alternatives for, order parameters that are required or optional for placing an options trading order.

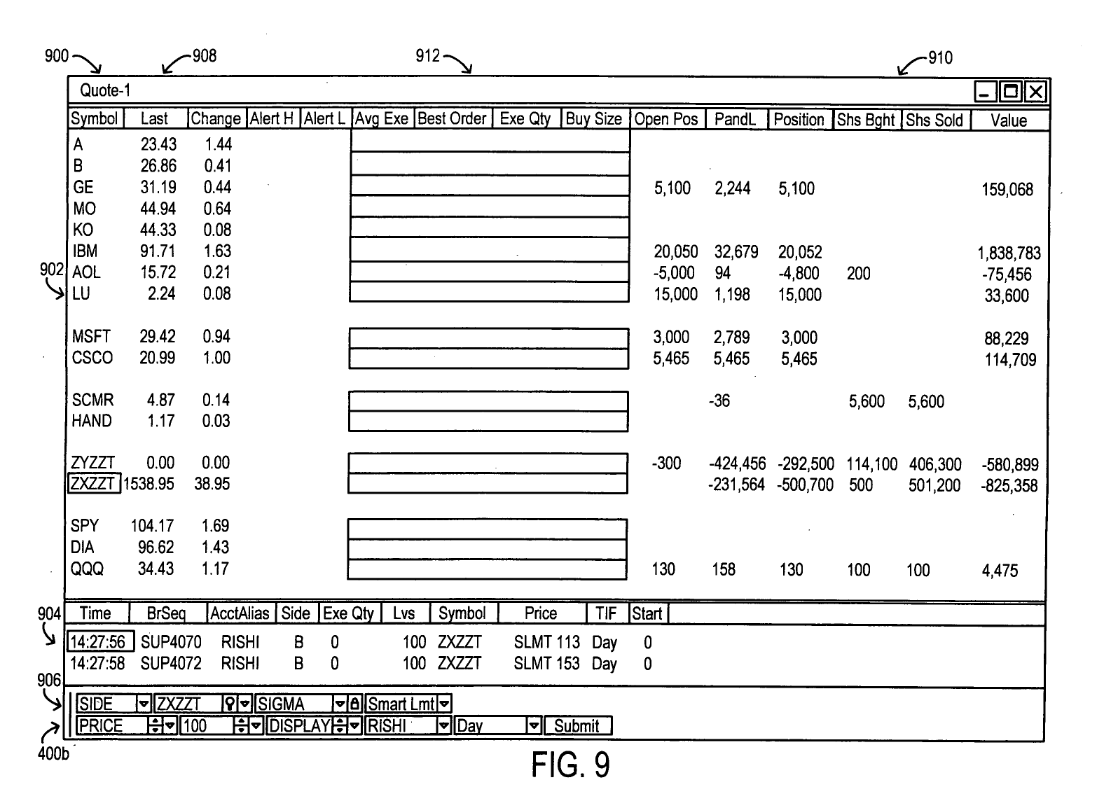

FIG. 9 shows a so-called “blotter” type view of a user interface in accordance with the present invention. The screen display area 900 shown in FIG. 9 includes an upper portion 902, a middle portion 904 and a lower portion 906 with a bar 400b being displayed in the lower portion 906. At a left side 908 of the upper portion 902, current market information may be displayed for a number of different financial instruments. At a right side 910 of the upper portion 902, information may be displayed with respect to current positions held in the financial instruments listed in the left side 908. At a central region 912 of the upper portion 902, information may be displayed in regard to order execution performance that has recently been experienced with respect to trading in the financial instruments listed in the left side 908.

The middle portion 904 of the screen display area 900 may display data entries that represent individual pending orders that were initiated by the user device 104 on which the display of FIG. 9 is being displayed.

The bar 400b shown in FIG. 9 is somewhat different in format from the bars 400 and 400a as shown in FIGS. 4-8 but may provide substantially the same functionality. As in the case of bars 400, 400a, the bar 400b may gather together a number of data input elements such as pull down menus by which a user may enter order parameter values.

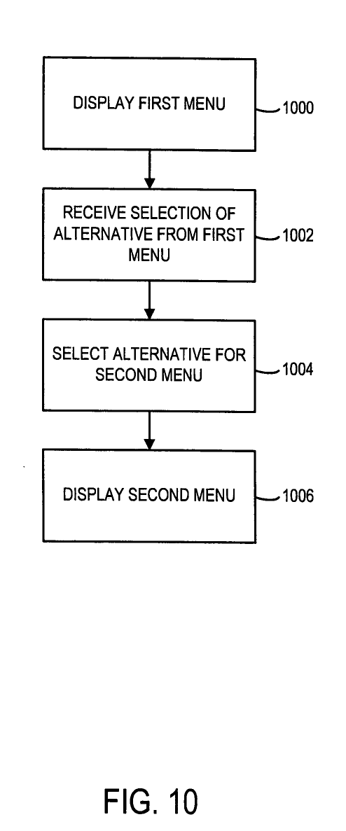

FIG. 10 is a flow diagram that illustrates an exemplary process for providing at least some of the interfaces shown in FIGS. 4-9. As indicated at 1000 in FIG. 10, a user device 104 may display a first menu, which may be a pull down menu that constitutes one of the order parameter data input elements referred to in connection with FIGS. 4-9. As indicated at 1002, the user device 104 and/or the order processing server 102 may receive the user's selection of one of the alternatives from the first menu. The user's selection may be indicated by using the cursor (not shown) to manipulate the first menu to select one of the alternatives presented by the first menu. Then, as indicated at 1004, and based at least in part on the alternative from the first menu selected by the user, the user device 104 and/or the order processing server 102 may select one or more alternatives to be displayed as part of a second menu. The second menu may be, for example, a pull down menu that constitutes another one of the order parameter data input elements referred to in connection with FIGS. 4-9. As indicated at 1006, the user device 104 may display the second menu including the one or more alternatives selected at 1004.

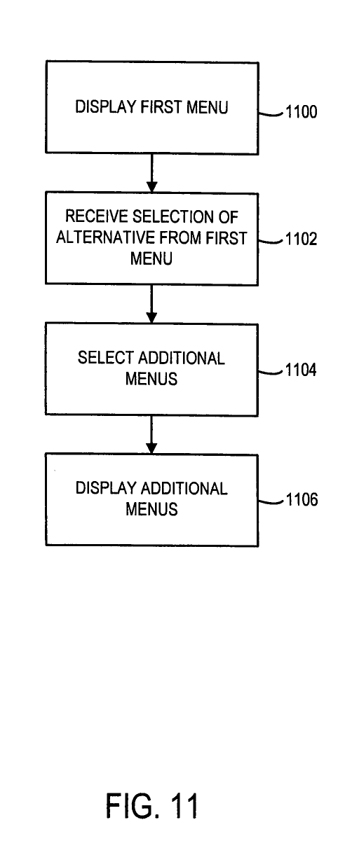

FIG. 11 is a flow diagram that illustrates an exemplary process for providing at least some of the interfaces shown in FIGS. 4-9. As indicated at 1100 in FIG. 11, a user device 104 may display a first menu, which may be a pull down menu that constitutes one of the order parameter data input elements referred to in connection with FIGS. 4-9. As indicated at 1102, the user device 104 and/or the order processing server 102 may receive the user's selection of one of the alternatives from the first menu. The user's selection may be indicated by using the cursor to manipulate the first menu to select one of the alternatives presented by the first menu. Then, as indicated at 1104, and based at least in part on the alternative from the first menu selected by the user, the user device 104 and/or the order processing server 102 may select one or more additional menus. The additional menu or menus may be, for example, pull down menus that constitute others of the order parameter data input elements referred to in connection with FIGS. 4-9. As indicated at 1106, the user device 104 may display the additional menu or menus selected at 1104. For example, a group of additional pull down menus to be displayed in the bar 400 may be selected based on one or more of the alternatives selected by the user from the pull down menus that constitute one or more of the data input elements 404, 406, 408.

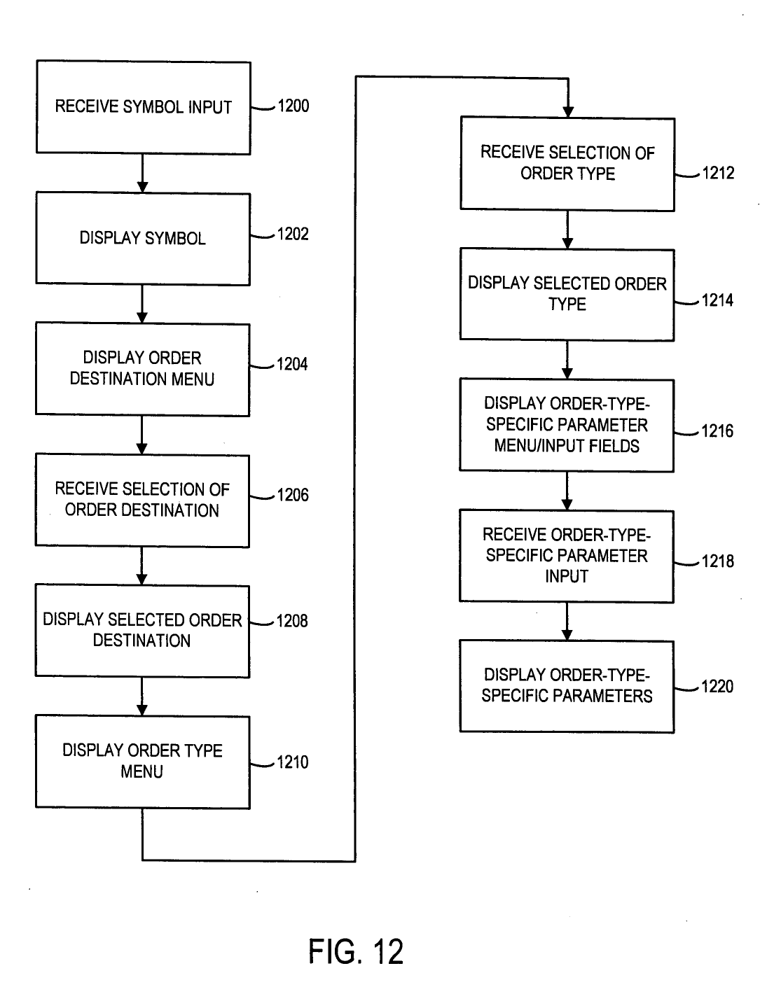

FIG. 12 is a flow diagram that illustrates an exemplary process for providing at least some of the interfaces shown in FIGS. 4-9. As indicated at 1200, at least one of the user device 104 and the order processing server 102 may receive a symbol that is input by the user of the user device 104. The receiving of the symbol input may, for example, result from the user's interaction with the symbol data input element 400 shown in FIGS. 4 and 5. For example, the user may utilize the keyboard (not separately shown) of the user device 104 to enter letters and/or numerals corresponding to the symbol in the data field 412 (FIG. 4) of the symbol data input element 404. Alternatively, the symbol may be entered in the data field 412 of the symbol data input element 404 in response to the user's operation of a symbol look-up function accessed by actuation of the look up button 414. As another alternative, the symbol may be entered in the data field 412 of the symbol data input element 404 in response to the user's selection of an alternative from a pull down menu accessed via the pull down button 410 of the symbol data input element 404.

As indicated at 1202, the user device 104 displays in the data field 412 of the symbol data input element 404 the symbol which corresponds to the symbol input received at 1200.

As indicated at 1204, the user device may display a pull down menu that constitutes the order destination data input element 406. The pull down menu displayed as the order destination data input element 406 may include alternatives that are selected to reflect order destinations that provide for trading of the financial instrument that is indicated by the symbol displayed at 1202 in the data field 412 of the symbol data input element 404. Thus, if a first symbol is displayed at 1202, a first order destination pull down menu may be displayed at 1204 corresponding to the order destinations that provide for trading of the financial instrument that is indicated by the first symbol; and if a second symbol is displayed at 1202, and the financial instrument that is indicated by the second symbol is traded at a different group of order destinations from the order destinations that trade the financial instrument that is indicated by the first symbol, then a second order destination pull down menu may be displayed at 1204 that is different from the first order destination pull down menu and that reflects the different group of order destinations that trade the financial instrument indicated by the second symbol. Either or both of the order processing server 102 and the user device 104 may store data that allows the order processing server 102 or the user device 104 to determine what order destination alternatives are to be included in the order destination menu in view of the symbol displayed at 1202.

As indicated at 1206, at least one of the user device 104 and the order processing server 102 may receive from the user an indication of the user's selection of an order destination. The receiving of the indication of the user's selection of the order destination may result from the user interacting with the order destination menu displayed at 1204. More specifically, the receiving of the indication of the user's selection of the order destination may result from the user's using the cursor to select an alternative that is displayed as part of the order destination menu.

As indicated at 1208, the user device 104 displays in the data field 412 of the order destination data input element 406 data which indicates the order destination selected by the user.

As indicated at 1210, the user device may display a pull down menu that constitutes the order type data input element 408. The pull down menu displayed as the order type data input element 408 may include alternatives that are selected to reflect order types that are supported by the order destination represented by the data displayed in the data field 412 of the order destination data input element 406 for trading the financial instrument indicated by the symbol displayed in the data field 412 of the symbol data input element 404. Thus, if a first order destination alternative is selected from the order destination pull down menu, a first order type pull down menu may be displayed at 1210 corresponding to the order types supported for trading of the indicated financial instrument by the order destination indicated by the first order destination alternative; and if a second order destination alternative is selected from the order destination pull down menu, and if the set of order types supported for trading the indicated financial instrument by the order destination indicated by the second order destination alternative is different from the set of order types supported for trading the indicated financial instrument by the order destination indicated by the first order destination alternative, then a second order type pull down menu may be displayed at 1210 that is different from the first order type pull down menu and that reflects the different set of order types supported for trading the indicated financial instrument by the order destination indicated by the second order destination alternative. Either or both of the order processing server 102 and the user device 104 may store data that allows the order processing server 102 or the user device 104 to determine what order type alternatives are to be included in the order type menu in view of the symbol displayed at 1202 and the order destination displayed at 1208.

As will be appreciated by those who are skilled in the art, some order destinations may currently operate to support up to two dozen or more different order types. In addition to the familiar market and limit order types, other order types that may be supported by a particular order destination include various types of reserve order, discretionary order types, tracking orders, pegged orders, PNP (post no preference) orders, stop orders, stop limit orders, directed orders, and so forth. Various different order destinations may support different sets of order types. Different types of orders may have different sets of parameters that are required or available to define the order.

As indicated at 1212, at least one of the user device 104 and the order processing server 102 may receive from the user an indication of the user's selection of an order type. The receiving of the indication of the user's selection of the order type may result from the user interacting with the order type menu displayed at 1210. More specifically, the receiving of the indication of the user's selection of the order type may result from the user's using the cursor to select an alternative that is displayed as part of the order type menu.

As indicated at 1214, the user device 104 displays in the data field 412 of the order type data input element 408 data which indicates the order type selected by the user.

Based on the combination of the symbol displayed at 1202, the selected order destination displayed at 1208 and the selected order type displayed at 1214, a certain set of order-type-specific parameters may be required or optional to complete the data input required to define the order to be submitted. The order destination server 102 and/or the user device 104 may operate to populate the bar 400 accordingly with additional data input elements to indicate to the user what additional parameters are needed or optional. As noted above, the data input elements and/or labels therefor may be color-coded or font-style-coded to indicate which data input elements correspond to required parameters and which data input elements correspond to optional parameters. Either or both of the order processing server 102 and the user device 104 may store data that allows the order processing server 102 or the user device 104 to determine what additional data input elements are to be displayed, and which are required or optional, in view of the selected combination of symbol, order destination and order type. The selection of particular menu alternatives to be included in individual ones of the additional data input elements may also be based on one or more of the selected symbol, the selected order destination, and the selected order type. Displaying of the appropriate additional data input elements is indicated at 1216 in FIG. 12. User input to select desired alternatives or otherwise to enter order parameter data may be received, as indicated at 1218, as a result of user interaction with some or all of the additional data input elements. As indicated at 1220, the user device 104 displays the user-selected parameter values corresponding to the additional data input elements as the user selections are received. Data which indicates all of the selected order parameter values may be displayed in the bar 400 at the text field 512 (FIG. 5). Once all required parameter values have been selected, the user may actuate the button 514 to cause the order to be executed.

The functionality indicated in FIGS. 10-12 may result from processor-executable process steps performed by either or both of the order processing server 102 and the user device 104.

The flow diagrams shown in FIGS. 10-12 should not be taken to imply a fixed order of steps. In various embodiments of the invention, process steps described herein may be performed in any order that is practicable.

The example screen displays shown in the accompanying drawings depict trading information relating to equity securities or options. However, the principles of the present invention are also applicable to other types of financial instrument trading, including trading in debt instruments, in currencies and in futures contracts such as commodities futures.

The user interface for order input in connection with financial instrument trading, as disclosed herein, may provide significant advantages to the user, by guiding him or her through the wide range of choices now available in terms of order destinations and order types. The information required to navigate the available choices may reside in the trading network, and may shape the alternatives presented to the user in such a way that the user is not required to know or memorize the data input requirements for the various combinations of symbol, order destination and order type. Thus the user interface according to the present invention may aid the user to operate successfully in today's complex financial instrument trading environment.

In some embodiments, the bar 400, 400a or 400b may be provided to allow a user to define parameters for any one of the following actions: entering an order, entering a ticket, canceling an order, updating an order, and reloading an order. In such embodiments the user may be allowed to select one action from among the set of the five actions enumerated in the previous sentence.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A method comprising:
displaying financial instrument trading information on a screen, the financial instrument trading information including a first menu for displaying a first set of alternatives with respect to a first order parameter;
receiving user input that indicates selection of an alternative from the first set of alternatives; and
displaying a second menu as part of the financial instrument trading information, the second menu for displaying a second set of alternatives with respect to a second order parameter, the second set of alternatives which constitute the second menu being selected based at least in part on the alternative selected by the user input from the first set of alternatives.

2. A method according to claim 1, wherein the first and second menus are adjacent each other at a lower portion of the screen.

3. A method according to claim 1, wherein the displayed financial instrument trading information includes respective quotations for a plurality of financial instruments.

4. A method according to claim 3, wherein the financial instruments are common stocks.

5. A method according to claim 1, wherein the displayed financial instrument trading information includes information concerning at least one financial instrument trading order.

6. A method according to claim 5, wherein the at least one financial instrument trading order includes at least one order to buy or sell a common stock.

7. A method according to claim 1, wherein the displayed financial instrument trading information includes respective quotations for a financial instrument at a plurality of order destinations.

8. A method according to claim 7, wherein the financial instrument is a common stock.

9. A method according to claim 1, wherein the first and second menus are pull down menus.

10. A method according to claim 1, wherein the first order parameter is a financial instrument trading symbol and the second order parameter is an order destination.

11. A method according to claim 1, wherein the first order parameter is an order destination and the second order parameter is an order type.

12. A method according to claim 1, further comprising:
allowing a user to select an action from among the following set of actions: (a) enter order; (b) enter ticket; (c) cancel order; (d) update order; and (e) reload order;
the selected action being defined at least in part by said first order parameter and said second order parameter.

13. A method comprising:
displaying financial instrument trading information on a screen, the financial instrument trading information including a first menu for displaying a first set of alternatives with respect to a first order parameter;
receiving user input that indicates selection of an alternative from the first set of alternatives; and
displaying a second menu as part of the financial instrument trading information, the second menu for displaying a second set of alternatives with respect to a second order parameter, the second menu selected based at least in part on the alternative selected by the user input from the first set of alternatives.

14. A method according to claim 13, wherein the first and second menus are pull down menus.

15. A method according to claim 13, wherein the displayed financial instrument trading information includes respective quotations for a plurality of financial instruments.

16. A method according to claim 15, wherein the financial instruments are common stocks.

17. A method according to claim 13, wherein the displayed financial instrument trading information includes respective quotations for a financial instrument at a plurality of order destinations.

18. A method according to claim 17, wherein the financial instrument is a common stock.

19. A method according to claim 13, further comprising:
allowing a user to select an action from among the following set of actions: (a) enter order; (b) enter ticket; (c) cancel order; (d) update order; and (e) reload order;
the selected action being defined at least in part by said first order parameter and said second order parameter.

20. A method comprising:
displaying a first order type menu at times when a first order destination alternative is selected from an order destination menu; and
displaying a second order type menu at times when a second order destination alternative is selected from the order destination menu, the second order type menu being different from the first order type menu.

21. A method comprising:
displaying a first order destination menu at times when a first financial instrument trading symbol is displayed in an order input area of a user interface; and
displaying a second order destination menu at times when a second financial instrument trading symbol is displayed in the order input area, the second order destination menu being different from the first order destination menu.

22. A method according to claim 21, wherein:
the first financial instrument trading symbol represents a first common stock; and
the second financial instrument trading symbol represents a second common stock.

23. A method according to claim 21, wherein:
the first financial instrument trading symbol represents a common stock; and
the second financial instrument trading symbol represents an option.

24. A medium storing processor-executable process steps, the process steps including:
a step to display financial instrument trading information on a screen, the financial instrument trading information including a first menu for displaying a first set of alternatives with respect to a first order parameter;
a step to receive user input that indicates selection of an alternative from the first set of alternatives; and
a step to display a second menu as part of the financial instrument trading information, the second menu for displaying a second set of alternatives with respect to a second order parameter, the second set of alternatives which constitute the second menu being selected based at least in part on the alternative selected by the user input from the first set of alternatives.

25. A medium according to claim 24, wherein the displayed financial instrument trading information includes respective quotations for a plurality of financial instruments.

26. A medium according to claim 25, wherein the financial instruments are common stocks.

27. A medium according to claim 24, wherein the displayed financial instrument trading information includes respective quotations for a financial instrument at a plurality of order destinations.

28. A medium according to claim 27, wherein the financial instrument is a common stock.

29. A medium according to claim 24, wherein the first order parameter is a financial instrument trading symbol and the second order parameter is an order destination.

30. A medium according to claim 24, wherein the first order parameter is an order destination and the second order parameter is an order type.

31. A medium storing processor-executable process steps, the process steps including:
a step to display financial instrument trading information on a screen, the financial instrument trading information including a first menu for displaying a first set of alternatives with respect to a first order parameter;
a step to receive user input that indicates selection of an alternative from the first set of alternatives; and
a step to display a second menu as part of the financial instrument trading information, the second menu for displaying a second set of alternatives with respect to a second order parameter, the second menu selected based at least in part on the alternative selected by the user input from the first set of alternatives.

32. A medium storing processor-executable process steps, the process steps including:
a step to display a first order type menu at times when a first order destination alternative is selected from an order destination menu; and
a step to display a second order type menu at times when a second order destination alternative is selected from the order destination menu, the second order type menu being different from the first order type menu.

33. A medium storing processor-executable process steps, the process steps including:
a step to display a first order destination menu at times when a first financial instrument trading symbol is displayed in an order input area of a user interface; and
a step to display a second order destination menu at times when a second financial instrument trading symbol is displayed in the order input area, the second order destination menu being different from the first order destination menu.

34. An apparatus comprising:
a processor; and
a storage device in communication with said processor and storing instructions adapted to be executed by said processor to:
display financial instrument trading information on a screen, the financial instrument trading information including a first menu for displaying a first set of alternatives with respect to a first order parameter;
receive user input that indicates selection of an alternative from the first set of alternatives; and
display a second menu as part of the financial instrument trading information, the second menu for displaying a second set of alternatives with respect to a second order parameter, the second set of alternatives which constitute the second menu being selected based at least in part on the alternative selected by the user input from the first set of alternatives.

35. An apparatus comprising:
a processor; and
a storage device in communication with said processor and storing instructions adapted to be executed by said processor to:
display financial instrument trading information on a screen, the financial instrument trading information including a first menu for displaying a first set of alternatives with respect to a first order parameter;
receive user input that indicates selection of an alternative from the first set of alternatives; and
display a second menu as part of the financial instrument trading information, the second menu for displaying a second set of alternatives with respect to a second order parameter, the second menu selected based at least in part on the alternative selected by the user input from the first set of alternatives.

36. An apparatus comprising:
a processor; and
a storage device in communication with said processor and storing instructions adapted to be executed by said processor to:
display a first order type menu at times when a first order destination alternative is selected from an order destination menu; and
display a second order type menu at times when a second order destination alternative is selected from the order destination menu, the second order type menu being different from the first order type menu.

37. An apparatus comprising:
a processor; and
a storage device in communication with said processor and storing instructions adapted to be executed by said processor to:
display a first order destination menu at times when a first financial instrument trading symbol is displayed in an order input area of a user interface; and
display a second order destination menu at times when a second financial instrument trading symbol is displayed in the order input area, the second order destination menu being different from the first order destination menu.
